(19) United States
(12) Patent Application Publication
(10) Pub. No.: US 2019/0246455 A1
(43) Pub. Date: Aug. 8, 2019

(54) BATHING WATER HEATING DEVICE

(71) Applicant: Lilypads, LLC, St. Louis, MO (US)

(72) Inventors: Chico Weber, St. Louis, MO (US); Spencer Toder, St. Louis, MO (US)

(21) Appl. No.: 16/268,948

(22) Filed: Feb. 6, 2019

Related U.S. Application Data
(60) Provisional application No. 62/626,741, filed on Feb. 6, 2018.

(51) Int. Cl. H05B 1/02; H05B 3/04; H05B 3/06; H05B 3/60; F24H 1/00; A61H 33/00

(52) U.S. Cl. CPC H05B 1/0283; H05B 3/04; H05B 3/06; H05B 2203/021; F24H 1/0081; A61H 33/60; A61H 33/0087; H05B 3/60

(57) ABSTRACT

A bath water heating device for use in a small water environment, such as a bathtub or the like, that is operable to maintain water in the small water environment at a desired temperature. The device may filter water as it is pumped through the device. Additionally or alternatively, the device may provide ambient relaxation and/or entertainment content to a user, such as a bather or the like. The device may be wirelessly connectable to external input/output devices.

### CROSS-REFERENCE TO RELATED APPLICATIONS

This Application claims priority to U.S. Provisional Patent Application Ser. No. 62/626,741, filed on Feb. 6, 2018, entitled “TUB HEATING DEVICE,” currently pending, the entire disclosure of which is incorporated herein by reference.

### TECHNICAL FIELD

The present invention relates generally to a water heating device, more particularly, to a heating device for use in small water environments (e.g., bathing vessels, bathtubs, etc.) to maintain a desired bathing water temperature.

### BACKGROUND

People have long enjoyed relaxing or cleaning themselves by bathing in bathtubs. However, a common complaint of those that enjoy baths is that the water cools too quickly, and the bath loses its relaxing qualities. Bathing in cool water is uncomfortable, and when the water begins to cool, bath time is often cut short.

Moreover, bathing in stagnant, sometimes dirty water can also diminish or eliminate the relaxing nature of a bath. The water can become dirty as a person sits and washes in the tub for prolonged periods of time, upwards of one hour. The water only becomes dirtier as bath salts, shampoos, soaps, and other bath products are added to the water.

The bathtub could be drained and re-filled with fresh hot water. However, this is a time-consuming operation and can be undesirable for various reasons, such as cost and environmental concerns, for example.

Larger, more technically advanced bathing environments like hot tubs, spas, and swimming pools have sophisticated heating pumps and filter systems that regulate the environment's temperature and filter the water, respectively. However, those systems are large and expensive. For example, the pump and filter systems require extra space outside the bathing environment and piping to transport the water between the bathing environment and the pump and filter system. Retrofitting an existing bathing environment to include these conventional systems is impractical (e.g., requiring demolition and remodeling, etc.), if not outright impossible. Furthermore, the conventional systems are not portable, rendering them usable only for the bathing environment in which they are installed. Moreover, conventional systems often need to be plugged into a wall outlet. This is not only impractical, but it is also dangerous.

As a result, such commercial heating devices are not built for use in consumer tubs like those used by people in their homes. A wireless consumer-sized heater that also filters bath water is needed in the consumer product market. The product should be simple to use, safe, relaxing, and non-intrusive when used in a home or hotel bath tub, or the like.

### SUMMARY

The invention generally pertains to a wireless tub heating device for use in a tub that preferably maintains bath water at a desired temperature. Moreover, the device may filter water as it is pumped through the device.

The heating device preferably includes a first, sealed environment that includes various types of (preferably wireless) electronic devices used to power the device, regulate the water temperature, and pump water through the device. That first, sealed environment is preferably watertight. Thus, when the tub heating device is used, those electronic components preferably do not come into contact with bath water and cause potential damage to the components and/or injure a bather.

A second environment preferably is in electronic communication with the electronic components in the first environment. It is also separably in fluid communication with the bath water. More specifically, the second environment preferably includes the water intake, pump, and output, so that water is pumped entirely within the second environment. The second environment also preferably includes a heating element that increases water temperature as necessary. The pump and heating element, however, are preferably electronically coupled to electronics (for example by hardwiring) contained within the first environment so that no electronic components are contained in the second environment exposed to water.

In use, water within a tub may be drawn in to the second environment by a pump via an intake exterior to the heating device. In a preferred embodiment, as that water is pumped into the second environment, it is also filtered by a charcoal (or similar) filter. Depending on a temperature reading from a thermostat or other temperature sensor (like a thermistor) which may be located exterior to the device, water passing through the second environment may be heated by a heating element contained within the second environment. Water then may be expelled from the output where it is returned to the tub.

More details are set forth below, but the heating device may include a number of other optional features. The above described aspects are merely illustrative of the innumerable aspects associated with the present invention and should not be deemed as limiting in any manner. These and other aspects, features and advantages of the present invention will become apparent from the following detailed description when taken in conjunction with the referenced drawings.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 is a block diagram of a bathing water heating device according to an example embodiment of the present invention.

FIG. 2 is an exploded elevation view of a bathing water heating device constructed according to an example embodiment of the present invention.

FIG. 3 is an exploded perspective view of the bathing water heating device of FIG. 2.

FIG. 4 is a transparent elevation view of the bathing water heating device of FIGS. 2 and 3.

FIG. 5 is a schematic illustrating some components of the bathing water heating device of FIGS. 2-4.

FIG. 6 is a perspective view of a bathing water heating device constructed according to another example embodiment of the present invention in a bathing water environment.

FIG. 7 is an elevation back view of the bathing water heating device of FIG. 6.

FIG. 8 is another perspective view of the bathing water heating device of FIGS. 6 and 7.

### DETAILED DESCRIPTION

In the following detailed description numerous specific details are set forth in order to provide a thorough understanding of the invention. However, it will be understood by those skilled in the art that the present invention may be practiced without these specific details. For example, the invention is not limited in scope to the particular type of industry application depicted in the figures. In other instances, well-known methods, procedures, and components have not been described in detail so as not to obscure the present invention.

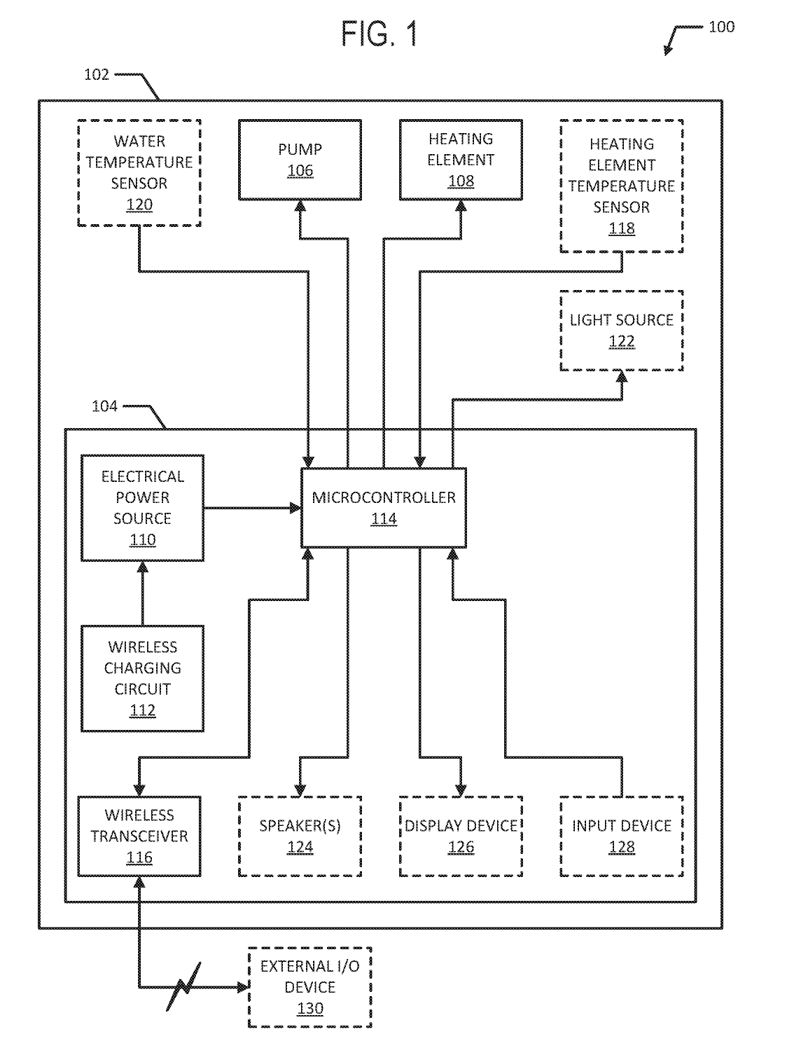

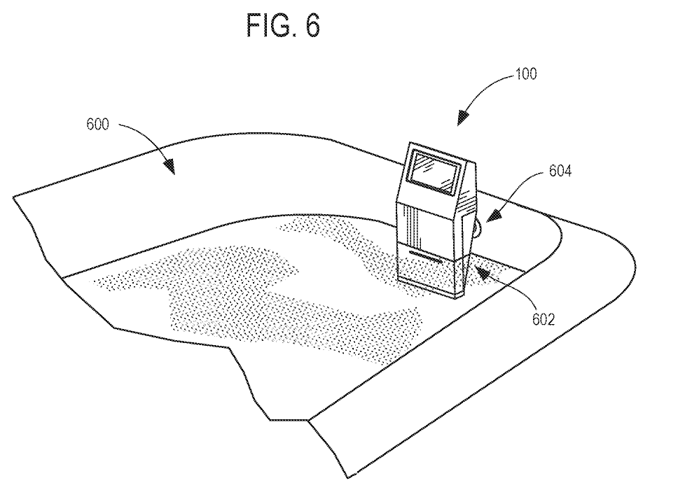

Turning first to FIG. 1, a block diagram of a bathing water heating device 100 (referred to hereinafter simply as “heating device 100”) is shown. As set forth below, the heating device 100 may be used in small water environments (e.g., small water environment 600 illustrated in FIG. 6), including, but not limited to, a bathtub (e.g., in a home, hotel, etc.), a sink, a pet washing station, an aquarium, and the like. The heating device 100 includes a housing 102, an inner container 104, a pump 106, a heating element 108, an electrical power source 110, a wireless charging circuit 112, a microcontroller 114, and a wireless transceiver 116. The pump 106, the heating element 108, the electrical power source 110, the wireless charging circuit 112, the microcontroller 114, and the wireless transceiver 116 are contained within the housing 102. In an embodiment, the electrical power source 110, the wireless charging circuit 112, the microcontroller 114, and the wireless transceiver 116 are contained within the inner container 104, which may be nestled within the housing 102.

The wireless charging circuit 112 is electrically connected to the electrical power source 110, which in turn is electrically connected to the microcontroller 114. The microcontroller 114 is electrically and/or communicatively connected to the wireless transceiver 116. In an embodiment, electric power is transferred from the electrical power source 110 to the wireless transceiver 116 via the microcontroller 114. Alternatively, the electrical power source 110 is electrically connected and directly provides electric power to the wireless transceiver 116. The electrical power source 110 and the microcontroller 114 are each in electronic communication with the pump 106 and the heating element 108. Preferably, the electrical power source 110 and the microcontroller 114 are hardwired to the pump 106 and the heating element 108 by waterproof cables, though other connections are envisioned.

In an embodiment, the heating device 100 optionally includes at least one of a heating element temperature sensor 118, a water temperature sensor 120, a light source 122, a speaker 124, a display device 126, and an input device 128, or combinations thereof. When present, the heating element temperature sensor 118, the water temperature sensor 120, the light source 122, the speaker 124, the display device 126, and the input device 128 are contained within the housing 102. In an embodiment, the speaker 124, the display device 126, and the input device 128, when present, are contained within the inner container 104, which may be nestled within the housing 102.

When present, the heating element temperature sensor 118, the water temperature sensor 120, the light source 122, the speaker 124, the display device 126, and the input device 128 are electrically and/or communicatively connected to the microcontroller 114. In an embodiment, electric power is transferred from the electrical power source 110 to the heating element temperature sensor 118, the water temperature sensor 120, the light source 122, the speaker 124, the display device 126, and/or the input device 128 via the microcontroller 114. Alternatively, the electrical power source 110 is electrically connected to and directly provides electric power to the heating element temperature sensor 118, the water temperature sensor 120, the light source 122, the speaker 124, the display device 126, and/or the input device 128.

The housing 102 is configured to house the components of the heating device 100. The housing 102 is configured to cover, protect, and/or support the inner container 104, the pump 106, the heating element 108, the electrical power source 110, the wireless charging circuit 112, the microcontroller 114, the wireless transceiver 116, the heating element temperature sensor 118 (when present), the water temperature sensor 120 (when present), the light source 122 (when present), the speaker 124 (when present), the display device 126 (when present), the input device 128 (when present), or combinations thereof while being sized and shaped to fit within at least a portion of a small water environment. In an embodiment, the size and shape of housing 102 are such that the heating device 100 can utilize space (e.g. a volume, etc.) within the small water environment that is unneeded by the bather (e.g., human, animal, etc.), and thus would typically go unutilized. As a non-limiting example, human bathers often fill a bathtub such that the water level line is near the bather's chest when the bather is seated in the bathtub. As such, there is a volume of water and/or air that may go unutilized (e.g., the portion of water from the water level line to the bather's legs and feet, the portion of air just above the water level line, etc.). By housing all of the components of heating device 100 within the housing 102 that is sized and shaped to fit within this volume of water and/or air, the heating device 100 can utilize this typically unutilized space. In some embodiments, the housing 102 is capable of floating the heating device 100 in water. Moreover, sizing and shaping the housing 102 such that the heating device 100 fits within at least a portion of a small water environment enables portability of the heating device 100 such that it can be utilized in a plurality of small water environments (e.g., multiple bathtubs within a home, in hotel bathtubs while traveling, etc.). Furthermore, sizing and shaping the housing 102 such that it houses the components of the heating device 100 and such that the heating device 100 fits within at least a portion of a small water environment eliminates the need to locate a pump and filter outside the water environment and eliminates the need for piping to transport the water between the bathing environment and the pump and filter system. In some embodiments, the housing 102 includes a cavity, as further described herein. Additionally, the housing 102 can include one or more inlet openings for allowing bath water to be drawn from the bath water environment outside the housing 102 into the cavity and/or one or more outlet openings for allowing heated bath water from the cavity to be ejected into the bath water environment outside the housing 102. In an embodiment, the housing 102 is comprised of polycarbonate plastic. Details of certain embodiments of the housing 102 are further described herein.

The inner container 104 is configured to contain (e.g., house) certain electronic components of the heating device 100. In an embodiment, the inner container 104 is closely sealed, fastened, or fitted such that liquid (e.g., water) cannot enter into or pass through the inner container 104 (i.e., the inner container 104 is impermeable to water). As such, when the heating device 100 is assembled, the inner container 104 is watertight, such that water cannot access and damage the electronic components therein. For example, the inner container 104 may cover, protect, and/or support, in a watertight manner, the electrical power source 110, the wireless charging circuit 112, the microcontroller 114, the wireless transceiver 116, the speaker 124 (when present), the display device 126 (when present), the input device 128 (when present), or combinations thereof. If water were to enter the inner container 104, the electronic components therein may be damaged, or if the heating device 100 were in use, a bather could be at risk of electric shock if the electronic components were exposed to the bath water. The inner container 104 is configured to be nestled within and coupled to the housing 102 when the heating device 100 is assembled. In some embodiments, the inner container 104 may be referred to as a cavity or environment. In an embodiment, the inner container 104 is comprised of a silicone membrane. Details of certain embodiments of the inner container 104 are further described herein.

The pump 106 is operable to move or transfer water (e.g., bath water) by mechanical action. In an embodiment, pump 106 is configured to draw bath water into itself through an inlet and force the bath water out through an outlet. By circulating water in this manner, the pump 106 is operable to draw bath water from the bath water environment outside the housing 102 into a cavity therein and to eject heated bath water from the cavity to the bath water environment outside the housing 102. One or more operations of the pump 106 may be controlled by the microcontroller 114 as further described herein. Details of certain embodiments of the pump 106 are further described herein.

The heating element 108 is operable to convert electrical energy into heat. In an embodiment during operation of heating device 100, an electric current provided by the electrical power source 110 encounters resistance when passed through the heating element 108, resulting in the generation of heat that is transferable to water (e.g., bath water) to raise the temperature of the water. The heating element 108 may be located with a cavity of the housing 102 and heat the bath water within the cavity. For example, locating the heating element 108 inside the housing 102 may help prevent a bather from coming into contact with the heating element 108 and burning himself or herself. In an embodiment, the heating element 108 is a 12 Volt, 40 Watt ceramic heating element. One or more operations of the heating element 108 may be controlled by the microcontroller 114 as further described herein. Details of certain embodiments of the heating element 108 are further described herein.

The electrical power source 110 is configured and/or operable to store and provide electric power to the electronic components of the heating device 100. For example, the electrical power source 110 may provide electric power to the pump 106, the heating element 108, the microcontroller 114, the wireless transceiver 116, the heating element temperature sensor 118 (when present), the water temperature sensor 120 (when present), the light source 122 (when present), the speaker 124 (when present), the display device 126 (when present), the input device 128 (when present), or combinations thereof. In an embodiment, the electrical power source 110 is an electric battery. An exemplary electric battery includes, but is not limited to, a lithium iron phosphate (LiFePO₄, “LFP”) battery. In an embodiment, the electrical power source 110 provides 12 Volts. Alternatively, the electrical power source 110 may provide 5 Volts. In an embodiment, the electrical power source 110 can provide electrical power for three hours of operation of heating device 100. Preferably, the electrical power source 110 is recharged via the wireless charging circuit 112 by being placed near a wireless charging pad, such as those known and understood in the art. This is preferred because it may reduce the frequency and/or need of a user (e.g., bather) to access the watertight inner container 104. One or more operations of the electrical power source 110 may be controlled by the microcontroller 114 as further described herein. Details of certain embodiments of the electrical power source 110 are further described herein.

The wireless charging circuit 112 is operable to receive power from an alternating electromagnetic field and convert it into electric current to charge the electrical power source 110. In an embodiment, the wireless charging circuit 112 includes an induction coil. The wireless charging circuit 112 may also include a rectifier (e.g., diode rectifiers comprised of field effect transistors, etc.) configured to rectify the received power, one or more capacitors configured to filter the received power, and/or a switching regulator. The wireless charging circuit 112 may operate according to a wireless power transfer standard, including but not limited to, the Qi standard, the Rezence standard, the WiPower standard, the Power Matters Alliance (PMA) standard, the Open Dots standard, or the like. In an embodiment, the wireless charging circuit 112 is a DC 5 Volt, 500 mA charging input. One or more operations of the wireless charging circuit 112 may be controlled by the microcontroller 114 as further described herein. Details of certain embodiments of the wireless charging circuit 112 are further described herein.

The microcontroller 114 is configured and/or operable to control operation of certain components of the heating device 100. In an embodiment, the microcontroller 114 includes at least one processor, memory, and one or more programmable input/output (I/O) interfaces. For example, one or more sets of instructions and data structures may be stored on the memory of the microcontroller 114 that, when executed by the processor of the microcontroller 114, control operations of and/or receive electrical signals from the pump 106 (e.g., activate the pump 106, deactivate the pump 106, alter operational properties of the pump 106, etc.), the heating element 108 (e.g., active the heating element 108, deactivate the heating element 108, alter the amount of heat generated by the heating element 108, etc.), the electrical power source 110 (e.g., activate the electrical power source 110, deactivate the electrical power source 110, alter operational properties of the electrical power source 110, etc.), the wireless charging circuit 112 (e.g., activate the wireless charging circuit 112, deactivate the wireless charging circuit 112, alter operational properties of the wireless charging circuit 112, etc.), the wireless transceiver 116 (e.g., activate the wireless transceiver 116, deactivate the wireless transceiver 116, alter operational properties of the wireless transceiver 116, etc.), the heating element temperature sensor 118 (when present) (e.g., activate the heating element temperature sensor 118, deactivate the heating element temperature sensor 118, receive temperature data from the heating element temperature sensor 118, etc.), the water temperature sensor 120 (when present) (e.g., activate the water temperature sensor 120, deactivate the water temperature sensor 120, receive temperature data from the water temperature sensor 120, etc.), the light source 122 (when present) (e.g., activate the light source 122, deactivate the light source 122, alter operational properties of the light source 122, etc.), the speaker 124 (when present) (e.g., activate the speaker 124, deactivate the speaker 124, alter operational properties of the speaker 124, provide audio signals to the speaker 124, etc.), the display device 126 (when present) (e.g., activate the display device 126, deactivate the display device 126, alter operational properties of the display device 126, provide video signals to the display device 126, etc.), the input device 128 (when present) (e.g., activate the input device 128, deactivate the input device 128, alter operational properties of the input device 128, receive input signals from the input device 128, etc.), or combinations thereof. In some embodiments, the microcontroller 114 controls an operating status and/or operating parameters of the pump 106 and the heating element 108 to maintain bathing water in which the heating device 100 is located at a desired temperature. Additionally or alternatively, the microcontroller 114 controls one or more operations of the wireless transceiver 116, the light source 122 (when present), the speaker 124 (when present), and/or the display device 126 (when present) to provide ambient relaxation and/or entertainment content to a user (e.g., a bather). In an embodiment, the at least one processor, memory, and one or more programmable I/O interfaces of the microcontroller 114 are embodied on a single integrated circuit (e.g., a “chip” or a “board”). In an embodiment, the microcontroller 114 includes a 5V microprocessing core. The microcontroller 114 may also include a fan that is configured to expel air from or move air across the at least one processor, memory, and/or one or more programmable I/O interfaces to cool them. Details of certain embodiments of the microcontroller 114 are further described herein.

The wireless transceiver 116 includes a transmitter and a receiver and is operable to transmit and receive radio waves, which enables the microcontroller 114 to communicate via wireless communications channels (i.e. wirelessly communicate). For example, the wireless transceiver 116 may transmit and receive radio waves having a frequency from 2.400 to 2.485 GHz in accordance with the IEEE 802.15.1 (e.g., Bluetooth®, Bluetooth® Low Energy, etc.) protocol standard and/or radio waves having frequencies in the 2.4, 5, and/or 60 GHz bands in accordance with the IEEE 802.11 (e.g., Wi-Fi®) protocol standard. Those skilled in the art will understand that the frequencies and communications protocols by which the wireless transceiver 116 may communicate are not limited to those described above, and that the wireless transceiver 116 may communicate via any wireless communication channel that enables the transfer of data between the microcontroller 114 and an external device. In an embodiment, the transmitter and the receiver share common circuitry. Alternatively, the transmitter and the receiver have no circuitry in common. The transmitter is configured to generate a radio frequency alternating current that is applied to an antenna of the wireless transceiver 116. The antenna is configured to radiate radio waves when excited by the alternating current from the transmitter. The antenna is further configured to receive radio waves and convert them to alternating currents that are applied to the receiver. The receiver is configured to extract desired information, such as by filtering a desired radio frequency signal from other signals received by the antenna, amplifying the filtered signal, and recovering desired information via demodulation. As such, the wireless transceiver 116 enables the transfer of data (e.g., information) between the microcontroller 114 and an external I/O device 130. Example external I/O devices 130 include, but are not limited to, a smartphone, a tablet computing device, a remote controller, a keyboard, a speaker (separate from speaker 124), a router, or the like, or combinations thereof. One or more operations of the wireless transceiver 116 may be controlled by the microcontroller 114 as further described herein. Details of certain embodiments of the wireless transceiver 116 are further described herein.

The heating element temperature sensor 118 is configured and/or operable to sense the temperature of the heating element 108 and provide temperature data to the microcontroller 114. The temperature data provided by the heating element temperature sensor 118 enables the microcontroller 114 to determine when the temperature of the heating element 108 is too hot (e.g., has exceeded a threshold value or maximum value, etc.). In response, the microcontroller 114 can control the heating element 108, such as by turning it off or reducing the temperature. One or more operations of the heating element temperature sensor 118 may be controlled by the microcontroller 114 as further described herein. Details of certain embodiments of the heating element temperature sensor 118 and the utilization of its temperature data by the microcontroller 114 are further described herein.

The water temperature sensor 120 is configured and/or operable to sense the temperature of the water environment in which the heating device 100 is located. In an embodiment, the water temperature sensor 120 is located within the interior of the heating device 100 (e.g., within the housing 102) and is in fluid communication with water inside the heating device 100. Additionally or alternatively, the water temperature sensor 120 is located exterior to the heating device 100 such that it is in contact with the water environment when the heating device 100 is in use. An exemplary water temperature sensor 120 includes, but is not limited to, a thermistor. The temperature data provided by the water temperature sensor 120 enables the microcontroller 114 to determine when water within which heating device 100 is located is too cold (e.g., has fallen below a threshold value or minimum value, etc.). In response, the microcontroller 114 can control the heating element 108, such as by turning it on or increasing the temperature. The operations of the water temperature sensor 120, the microcontroller 114, and the heating element 108 may thus operate much like a closed thermostat system in a household. One or more operations of the water temperature sensor 120 may be controlled by the microcontroller 114 as further described herein. Details of certain embodiments of the water temperature sensor 120 and the utilization of its temperature data by the microcontroller 114 are further described herein.

The light source 122 is operable to emit electromagnetic radiation within the visible portion of the electromagnetic spectrum. An exemplary light source 122 includes, but is not limited to, one or more light-emitting diodes (LEDs). For example, the LEDs may comprise an LED light ring or an LED light bar affixed to an exterior surface of the housing 102. The light source 122 may emit ambient lighting above and/or below the water level line when the heating device 100 is in use. The lighting may be for safety and/or aesthetic purposes. In an embodiment, properties of the light, such as on/off status, color, intensity, duration, pulses, and the like can be controlled by microcontroller 114. One or more operations of the light source 122 may be controlled by the microcontroller 114 as further described herein. Details of certain embodiments of the light source 122 are further described herein.

The speaker 124 is operable to convert an electrical audio signal (e.g., from microcontroller 114, etc.) into corresponding audible sound. In an embodiment, the housing 102 includes a cap member with openings to allow sound to emanate from the speaker 124, as further described herein. Inclusion of the speaker 124 can enable a user (e.g., bather) to listen to music or hear audio content associated with video content while taking a bath. Music and other audio content produced by the speaker 124 may be controlled by the external I/O device 130. In an embodiment, the speaker 124 is a 40 mm waterproof speaker. One or more operations of the speaker 124 may be controlled by the microcontroller 114 as further described herein. Details of certain embodiments of the speaker 124 are further described herein.

The display device 126 is operable to present information supplied by an electrical signal in a visual format. In an aspect, the display device 126 is operable to receive an analog or digital electrical signal that conveys information from the microcontroller 114 and present the information in a visual format. For example, the information may be about a status of the pump 106 (e.g., active, inactive, error, usage data, etc.), a status of the heating element 108 (e.g., active, inactive, error, usage data, temperature, etc.), a status of the electrical power source 110 (e.g., charge percentage, “life” remaining, etc.), a status of the wireless charging circuit 112 (e.g., active, inactive, error, etc.), a status of the microcontroller 114 (e.g., error, etc.), a status of the wireless transceiver 116 (e.g., active, inactive, error, usage data, connection status, connection information, connection type, etc.), a status of the heating element temperature sensor 118 (e.g., active, inactive, error, temperature, etc.), a status of the water temperature sensor 120 (e.g., active, inactive, error, temperature, etc.), a status of the light source 122 (e.g., active, inactive, error, color(s), timing, brightness, etc.), a status of the speaker 124 (e.g., active, inactive, error, volume, sound properties, etc.), a status of the display device 126 itself (e.g., active, inactive, error, display properties, etc.), a status of the input device 128 (e.g., active, inactive, error, input properties, etc.), or combinations thereof. In an embodiment, the display device 126 includes a display (i.e., a “screen”), a bezel, and/or a display housing. The display may be a two-dimensional display that utilizes one or more technologies understood by those skilled in the art, such as light-emitting diode (LED) display technology, electroluminescent display (ELD) technology, plasma display panel (PDP) technology, liquid crystal display (LCD) technology, organic LED (OLED) display technology, digital light processing (DLP) display technology, quantum dot display (QLED) technology, or the like, or combinations thereof. It is also envisioned that the display may be a three-dimensional display that utilizes technologies such as swept-volume display technology, holographic display technology, or the like, or combinations thereof. In an embodiment, aspects of the display device 126 and the input device 128 are combined into a single device. For example, the display device 126 and the input device 128 may be embodied in a touchscreen device. One or more operations of the display device 126 may be controlled by the microcontroller 114 as further described herein. Details of certain embodiments of the display device 126 are further described herein.

The input device 128 is operable to receive an input from a user (e.g., a bather) and provide data and/or control signals representing the input to the microcontroller 114. In an embodiment, the input device 128 is one or more soft-touch buttons. In another embodiment, the input device 128 is a touchscreen interface that is combined with aspects of the display device 126. Additionally or alternatively, the input device 128 may include a camera (e.g., visual data input, gesture input, etc.) and/or a microphone (e.g., audio/voice input). One or more operations of the input device 128 may be controlled by the microcontroller 114 as further described herein. Details of certain embodiments of the input device 128 are further described herein.

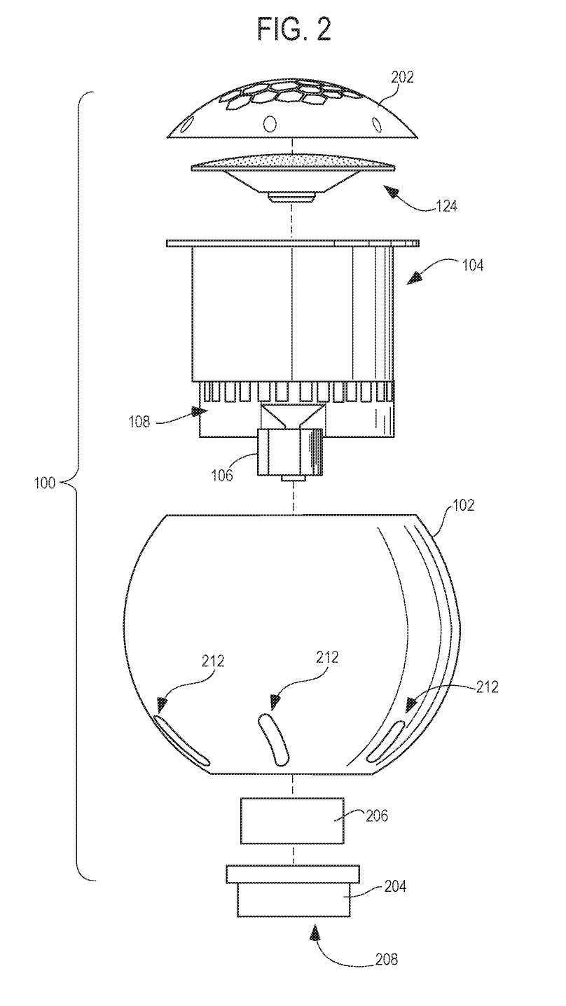

FIGS. 2-5 illustrate aspects of the heating device 100 constructed according to an example embodiment of the present invention. In this embodiment, the heating device 100 includes the housing 102, the inner container 104, the pump 106, the heating element 108, the electrical power source 110, the wireless charging circuit 112, the microcontroller 114, the wireless transceiver 116, the heating element temperature sensor 118, the water temperature sensor 120, the light source 122, the speaker 124, an upper cap member 202, a lower cap member 204, and a filter 206. As shown in FIG. 2, the heating device 100 may be generally spherical in shape. For example, the heating device 100 may have an outer diameter of less than six inches, such as 5.91 inches (150 millimeters). In an embodiment, the aforementioned size and shape of the heating device 100 enable it to utilize space (e.g., a volume) within a small water environment (e.g., small water environment 600 illustrated in FIG. 6) that is unneeded by the bather and is thus typically unutilized. For example, the heating device 100 may float in an area of the small water environment that is unutilized by a bather. In alternative embodiments, the heating device 100 may be more puck-shaped. In other embodiments not provided herein, the heating device 100 may take on another shape altogether that is able to perform the functions described below.

As shown in FIG. 2, the heating device 100 preferably includes the housing 102 which may contain various components of the heating device 100 therein when the heating device 100 is assembled. In the embodiment illustrated in FIG. 2, the housing 102 is principally spherical, but in alternative embodiments, the housing 102 may take on a nearly limitless number of different shapes and sizes. For example, the housing 102 may be a cylinder with a relatively short height such that the housing 102 is principally puck-shaped.

The inner container 104 is also preferably provided that may be nestled within and coupled to the housing 102 when the heating device 100 is assembled. As further described herein, the inner container 104 preferably contains a number of electronic components that may be used to operate the heating device 100. As such, when the heating device 100 is assembled, the inner container 104 is watertight, such that water cannot access and damage the electronic components therein. If water were to enter the inner container 104, the electronic components may be damaged, or if the heating device 100 were in use, a bather could be at risk of electric shock if the electronic components were exposed to the bath water.

As shown in FIG. 2, the heating device 100 may also be provided with a lower cap member 204 that is releasably engageable with a bottom portion of the housing 102. In some embodiments, for example the puck-shaped heating device, the lower cap member 204 and the housing 102 may be integrally formed, or even one in the same. The lower cap member 204 preferably includes an opening or plurality of openings (not illustrated in FIG. 2) through which water from within the small water environment (e.g., bathtub, etc.) may be drawn by the pump 106 or other mechanical device. In the embodiment illustrated in FIG. 2, the filter 206 is also provided that is disposed within the lower cap member 204 such that it is positioned between the inlet opening and the cavity such that the bath water drawn from the bath water environment into the cavity through the inlet opening passes through the water filter before reaching the cavity. In other embodiments, the filter 206 may be located elsewhere in the flow pattern of water described herein within the heating device 100. The filter 206 may remove impurities (e.g., bath salts, shampoos, soaps, etc.) in the water drawn into the heating device 100. For example, the filter 206 may be a charcoal filter, a granular-activated carbon (GAC) filter, a depth filter, a metallic alloy filter, a microporous ceramic filter, a carbon block resin (CBR) filter, or the like. In an embodiment, the filter 206 can be utilized for fourteen days before replacement.

When water is introduced into the heating device 100 in the manner described herein, the water may be filtered by the filter 206. The specific manner in which the heating device 100 pumps water into the heating device 100 for filtration and/or temperature regulation is described in greater detail herein.

At its upper end, the heating device 100 is preferably provided with an upper cap member 202 that is preferably releasably engageable with the housing 102. For example, the upper cap member 202 may be releasably engaged with the housing 102 via fasteners, such as stainless steel bolt fasteners for example. In alternative embodiments, the upper cap member 202 and the housing 102 may be integrally formed, or even one in the same, in much the same way as the lower cap member 204. In a preferred embodiment, the upper cap member 202, the housing 102, and the lower cap member 204 make up the components of the heating device 100 that are visible when the heating device 100 is assembled. In one embodiment, the speaker 124 may also be provided that is in electronic communication with the various electronic components within the inner container 104 as described herein. That way, should a user (e.g., a bather) wish to listen to music while utilizing the small water environment (e.g., taking a bath) he or she may be able to safely do so.

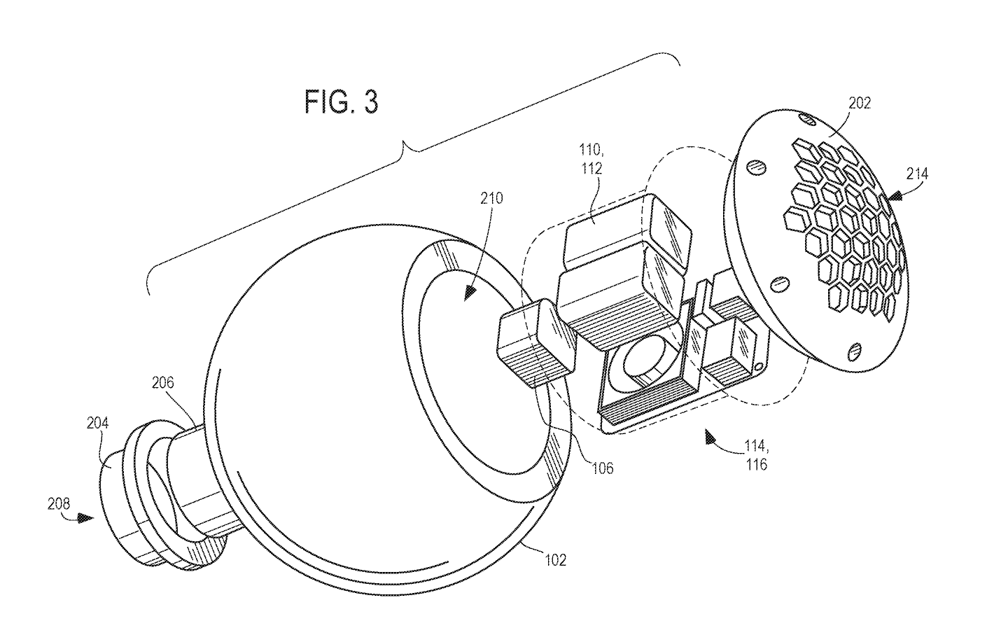

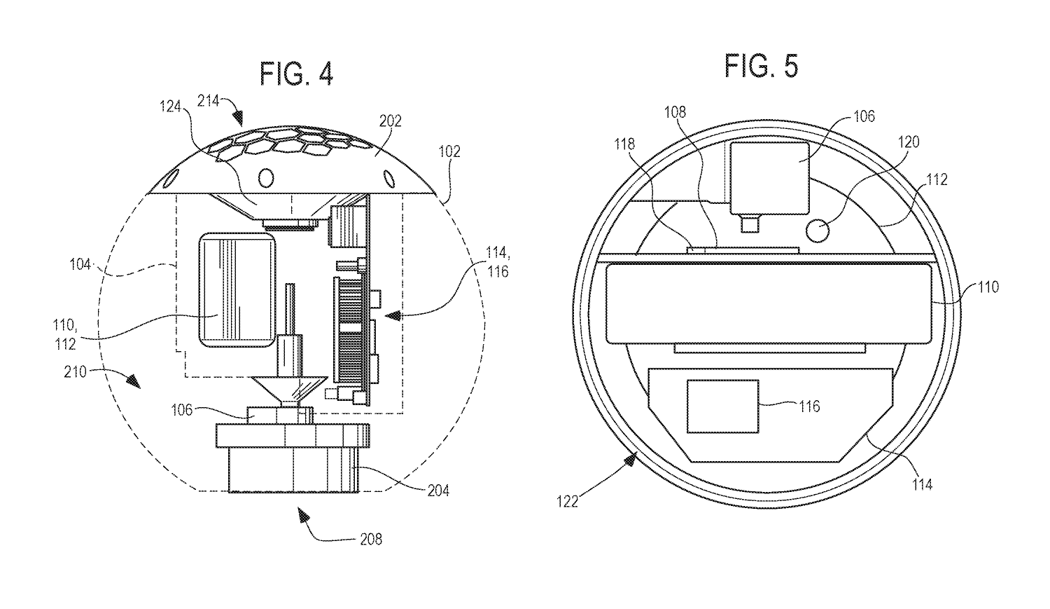

Turning now to FIGS. 3 and 4, a lower surface of the lower cap member 204 that is in fluid communication with bath water when the heating device 100 is in a bath tub may be provided with one or more inlet openings 208. The inlet openings 208 preferably allow for water to be drawn into the heating device 100 when the heating device 100 is functioning in the manner described herein. The housing 102, as eluded to above, is preferably provided with a first environment or cavity 210. This first cavity 210 preferably receives and contains the inner container 104 when the inner container 104 is releasably engaged within the housing 102. While the inner container 104 takes up a significant volume of the first cavity 210 when it is within the housing 102, there is still sufficient volume within the first cavity 210 for water to be drawn in separately from the inner container 104. In an embodiment, it is within this volume of the first cavity 210 that is not utilized by the inner container 104 that the water therein is heated by the heating element 108.

Within that portion of the first cavity 210 not occupied by the inner container 104, the pump 106 similar to those known in the art is preferably provided so that it is in fluid communication with water when heating device 100 is utilized. On a side portion of the housing 102, one or more outlet openings 212 may also be provided through which heated and/or filtered water may be ejected after heating and/or filtering. When the heating device 100 is on and functioning, the pump 106 may act to draw water from the tub or other water container via the inlet openings 208 formed within the lower cap member 204. After regulating that water's temperature (if necessary), the pump 106 ejects water from the outlet openings 212.

It should be noted that in some embodiments, when the pump 106 is activated to draw water in, the water may be filtered by the filter 206 or a similar filter before being passed through the heating device 100. Similarly, it should be noted that the outlet openings 212 may be located in numerous locations. In a preferred embodiment, the outlet openings 212 are preferably sufficiently distant from inlet openings 208 that water ejected from the outlet openings 212 may not be immediately redrawn into the heating device 100. If the outlet openings 212 are too close to the inlet openings 208, an inaccurate temperature reading may take place because only heated water is measured. Those skilled in the art will understand that the outlet openings 212 may be located farther from the inlet openings 208 than what is illustrated in FIGS. 2-5.

In addition to the pump 106, the heating element 108 is preferably provided within the heating device 100 that also may be in contact with water that is passed through the heating device 100. In a preferred embodiment such as that shown in FIGS. 2 and 3, the heating element 108 is not directly in communication with the larger volume of bath water (e.g., within the bath tub) and instead is only in communication with water that is contained within the first cavity 210. That way, it is less likely that a user (e.g., a bather) will come into contact with the heating element 108 and injure his or herself by touching the hot heated element 108.

A thermostat such as a thermistor is also preferably provided exterior to the heating device 100 so that it is in contact with water when the heating device 100 is in use. The thermostat should also be in electronic or data communication with the microcontroller 114. In an embodiment, the thermostat comprises the water temperature sensor 120.

Within the inner container 104, the electrical power source 110, the wireless charging circuit 112, the microcontroller 114, the wireless transceiver 116, and the speaker 124 are preferably provided. The electrical power source 110 and the microcontroller 114 are each preferably in electronic communication with the pump 106 and the heating element 108. Preferably, the electrical power source 110 and the microcontroller 114 are each hardwired to the pump 106 and the heating element 108 by waterproof cables, though other connections are envisioned.

The electrical power source 110 is preferably a rechargeable, wireless power source, such as a lithium ion battery or the like. Preferably, the electrical power source 110 may be recharged by being placed on a wireless charging pad, like those known and understood in the art. This is preferred because it may reduce the frequency and/or a need of a bather to access what should be a water tight container (the inner container 104).

The microcontroller 114 is preferably of any type known or understood in the art that is able to control electronics such as the heating element 108, its associated thermistor or heating element temperature sensor 118 or water temperature sensor 120, the electrical power source 110, the speaker 124, the pump 106, and other accessories that may or may not be present with the heating device 100. In some embodiments, the microcontroller 114 may have wired connections with the various aforementioned components, and in other embodiments it may be wirelessly connected, for example using wireless data transfer technology like Bluetooth® technology.

When the heating device 100 is used, the external I/O device 130, such as a remote control or a mobile device such as an iPhone®, smartphone with an Android® operating system, or other smartphone may be used to control the heating device 100. When the heating device 100 is activated, a user may first use the external I/O device 130 (e.g., remote control, smartphone or the like) to set a desired bath water temperature. As part of its routine operation, the microcontroller 114 preferably commands the pump 106 to periodically or continuously (depending on a user's preference) pull water from the small water environment (e.g., bathtub) near the lower cap member 204, for example via the inlet openings 208. As it does so, a filter such as the filter 206 may filter the bath water. At the same time, the above described thermostat or water temperature sensor 120, which is in fluid communication with the first water in the first cavity 210 may measure that water's temperature. Additionally or alternatively, the thermostat may take the temperature reading from a location elsewhere on the exterior of the heating device 100.

The measured temperature may then be relayed to the microcontroller 114, which determines whether the water needs to be heated to maintain the desired user's temperature. If it determines heating is necessary to reach a set temperature, the heating element 108 may output an appropriate amount of heat as calculated by the microcontroller 114 that is necessary to raise the temperature of the water within the first cavity 210. The pump 106 may then eject that heated water at a sufficiently far distance from the inlet openings 208 so that the same water is not measured the next time the pump 106 is in operation. The operations of the thermistor and the heating element 108 may operate much like a closed thermostat system in a household.

In embodiments where the heating device 100 includes a speaker such as the speaker 124, the electrical power source 110 and the microcontroller 114 may be used to control the speaker 124. When the speaker 124 is utilized, the upper cap member 202 may be provided with openings 214 to allow sound to emanate from the speaker 124. Music played on the speaker 124 may be controlled by the external I/O device 130, such as a remote control in some embodiments or in other embodiments by a user's smartphone or other smart device. Operation of the speaker 124, like operation of the temperature regulation system, may be carried out by the microcontroller 114.

Turning now to FIG. 5, the heating element temperature sensor 118 may also be provided that monitors the temperature of the heating element 108. When the microcontroller 114 determines, based on the temperature data provided by the heating element temperature sensor 118, that the heating element 108 is nearing or at a temperature that is too hot, microcontroller 114 deactivates (e.g., turns off) the heating element 108 or reduces the amount of heat generated by the heating element 108.

The water temperature sensor 120 is also shown as an exemplar thermostat, such as the thermostat that was described herein above. In this embodiment, the water temperature sensor 120 is within the interior of the heating device 100, though as mentioned above, it may also be present on the exterior of the heating device 100.

The microcontroller 114 is also shown with the wireless transceiver 116 that may operate in a known manner with the external I/O device 130 (e.g., a remote control or smartphone, etc.) to control the various operations of the heating device 100 wirelessly (for example by utilizing Bluetooth® technology). Similarly, the wireless charging circuit 112 for charging the electrical power source 110 is also provided.

Also provided in FIG. 5 is the light source 122 embodied in an LED light ring that circumscribes the heating device 100. In some embodiments, the LED light ring comprising the light source 122 is provided as a ring such as that shown in FIG. 5, but in alternative embodiments, it may be a plurality of LEDs or other types of lights that are present elsewhere on the heating device 100. The displays of the LED light ring or other light display comprising the light source 122 may be powered by the electrical power source 110 and controlled by the microcontroller 114, much like the other components described herein.

While not illustrated in FIGS. 1-5, the heating device 100 may also be provided with a water level sensor. The water level sensor is preferably located exterior to the heating device 100. The water temperature sensor is preferably in electric communication with the electrical power source 110 and the microcontroller 114. Being powered by the electrical power source 110, the water level sensor preferably periodically and/or continuously measures the amount of water adjacent to its sensor. If the water level sensor senses that it is not adjacent water, it may be instruct the microcontroller 114 to shut down all operations of the heating device 100. That way, if the heating device 100 has been removed from a small water environment (e.g., bathtub), it does not stay on and generate potentially dangerous high temperatures.

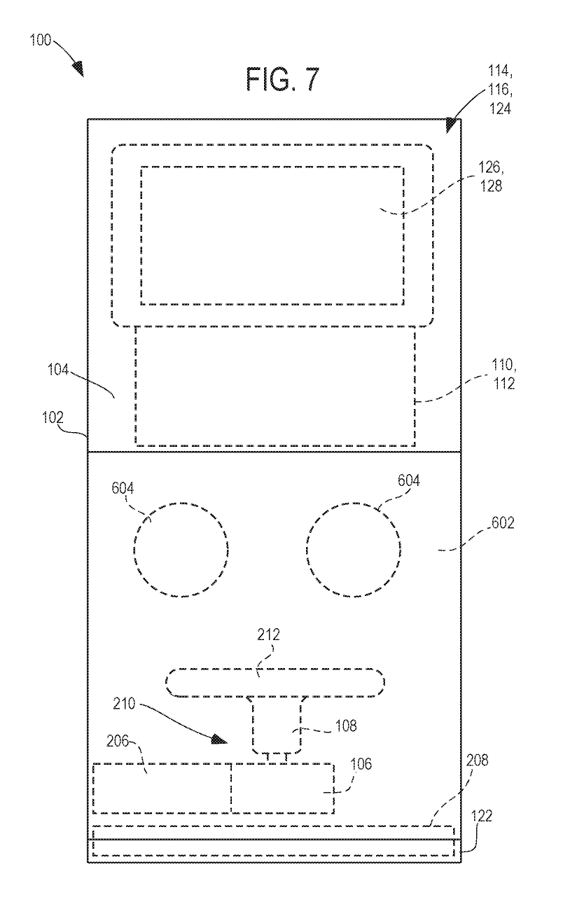

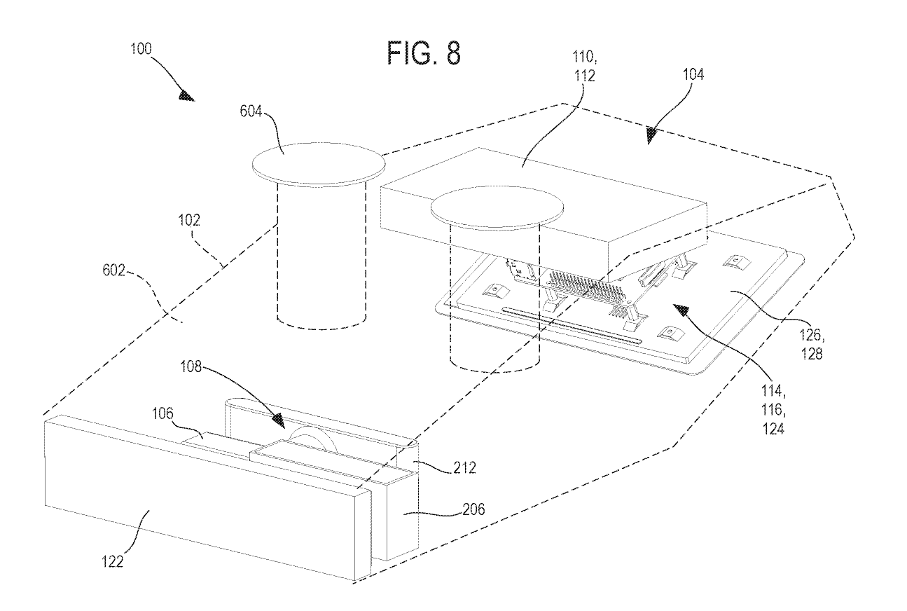

FIGS. 6-8 illustrate aspects of the heating device 100 constructed according to another example embodiment of the present invention. In this embodiment, the heating device 100 includes the housing 102, the inner container 104, the pump 106, the heating element 108, the electrical power source 110, the wireless charging circuit 112, the microcontroller 114, the wireless transceiver 116, the light source 122, the speaker 124, the display device 126, and the input device 128. In this embodiment, aspects of the display device 126 and the input device 128 are combined into a single touchscreen device. Furthermore, the housing 102 includes the inlet openings 208 and the outlet openings 212. FIG. 6 illustrates this embodiment of the heating device 100 in a small water environment 600, which is a bathtub in the illustrated embodiment. As illustrated, a portion of the heating device 100 is submerged in the water and a portion of the heating device 100 is above the water level line. The housing 102 of this embodiment of the heating device 100 includes a tapered back surface portion 602. The tapered back surface portion 602 enables the heating device 100 to accommodate a sloping surface of the small water environment 600, such as a bathtub wall for example. In an embodiment, the heating device 100 further includes one or more suction cups 604. The one or more suction cups 604 are configured to adhere to a nonporous surface of the bath water environment (e.g., a bathtub wall, etc.), thereby releasably affixing at least a portion of the heating device 100 to the nonporous surface.

In this embodiment, the microcontroller 114, the touchscreen device (i.e., the display device 126 and the input device 128), and the electrical power source 110 are designed to be above water. Alternatively, these aforementioned components may be located within the inner container 104. The pump 106, the heating element 108, and the light source 122 (e.g., LED strip) are all designed to be submerged in the water during use of the heating device 100 in a small water environment. In an embodiment, the pump 106 and the heating element 108 operate simultaneously to both filter and heat the water without using the water temperature sensor 120. For example, the electrical power source 110 may output 5 Volts, which causes the heating element 108 to produce a steady state of lower heat (e.g., lower relative to a 12-Volt electrical power source 110) and thus does not require the water temperature sensor 120. In an embodiment, the electrical power source 110 can be charged via the wireless charging circuit 112 while being utilized in the small water environment 600. Alternatively, the electrical power source 110 can be quickly swapped out with a charged electrical power source (e.g., battery) while in use.

In an embodiment, the microcontroller 114 receives commands from the touchscreen device and in response can alter a state or operating parameter of the pump 106 and/or the heating element 108. In a further embodiment, the microcontroller 114 receives commands from the touchscreen device and in response can alter a state or operating parameter of the LED strip comprising the light source 122.

In an embodiment, the microcontroller 114 utilizes the wireless transceiver 116 to communicate with the external I/O device 130 (e.g., keyboard, remote controller, speakers, etc.) via Wi-Fi® and/or Bluetooth® communication protocols. This allows for a bather to watch video content and/or listen to music while using the heating device 100. In an embodiment, the touchscreen device comprising the display device 126 and the input device 128 is water resistant. In another embodiment, the microcontroller 114 can track operating statuses and/or properties of the components of heating device 100 and generate alerts for display via the touchscreen device and/or the external I/O device 130. For example, the microcontroller 114 can alert when to change the filter 206 and/or when a charge of the electrical power source 110 is running low. In yet another embodiment, the housing 102 is sized and shaped to enable the heating device 100 to be rested on a bridge-like structure or platform spanning across the small water environment 600 to enable the heating device 100 (and thus the touchscreen device, display device 126, etc.) to be closer to the bather. For example, the housing 102 may include one or more grooves or the like that enable the heating device 100 to be rested on the bridge-like structure or platform.

Those skilled in the art will understand the description above describes embodiments of a wireless bath water heating device for use in a small water environment (e.g., a bathtub) that preferably maintains bath water at a desired temperature. Moreover, the device may filter water as it is pumped through the device. Additionally or alternatively, the device may provide ambient relaxation and/or entertainment content to a user (e.g., a bather).

In an aspect, an apparatus (e.g., heating device 100) includes a pump (e.g., pump 106), a heating element (e.g., heating element 108), and a housing (e.g., housing 102). The housing encloses the pump and the heating element within a cavity (e.g., cavity 210) inside the housing. The housing includes at least one inlet opening (e.g., inlet opening 208) and at least one outlet opening (e.g., outlet opening 212). Moreover, the housing is sized and shaped to fit within at least a portion of a bath water environment (e.g., small water environment 600). The pump is operable to draw bath water from the bath water environment outside the housing into the cavity through the inlet opening. The heating element is operable to heat the bath water within the cavity. The pump is further operable to eject the heated bath water from the cavity to the bath water environment outside the housing through the outlet opening.

In another aspect, a heating device (e.g., heating device 100) preferably includes a first, sealed environment (e.g., inner container 104) that includes various types of electronic devices used to power the device (e.g., electrical power source 110, wireless charging circuit 112) and regulate the water temperature and pumping of water through the device (e.g., microcontroller 114). That first, sealed environment is preferably watertight. Thus, when the heating device is used, those electronic components preferably do not come into contact with bath water and cause potential damage to the components and/or injure a bather. A second environment (e.g., cavity 210) preferably is in electronic communication with the electronic components in the first environment. It is also separably in fluid communication with the bath water. More specifically, the second environment preferably includes the water intake (e.g., inlet openings 208), pump (e.g., pump 106), and output (e.g., outlet openings 212), so that water is pumped entirely within the second environment. The second environment also preferably includes a heating element (e.g., heating element 108) that increases water temperature as necessary. The pump and heating element, however, are preferably electronically coupled to electronics (for example by hardwiring) contained within the first environment so that no electronic components are contained in the second environment exposed to water. In use, water within a small water environment (e.g., bathtub) may be drawn in to the second environment by the pump via the water intake. In a preferred embodiment, as that water is pumped into the second environment, it is also filtered by a charcoal (or similar) filter (e.g., filter 206). Depending on a temperature reading from a thermostat or other temperature sensor (like a thermistor) (e.g., water temperature sensor 120) which may be located exterior to the device, water passing through the second environment may be heated by the heating element contained within the second environment. Water then may be expelled from the output where it is returned to the small water environment (e.g., bathtub).

The preferred embodiments of the invention have been described above to explain the principles of the invention and its practical application to thereby enable others skilled in the art to utilize the invention in the best mode known to the inventors. However, as various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by the above-described exemplary embodiment, but should be defined only in accordance with the following claims appended hereto and their equivalents.

What is claimed is:

1. An apparatus for heating bath water, comprising:
a pump;
a heating element; and
a housing, wherein the housing encloses the pump and the heating element within a cavity therein, wherein the housing has at least one inlet opening and at least one outlet opening, and wherein the housing is sized and shaped to fit within at least a portion of a bath water environment,
wherein the pump is operable to draw bath water from the bath water environment outside the housing into the cavity through the inlet opening,
wherein the heating element is operable to heat the bath water within the cavity, and
wherein the pump is further operable to eject the heated bath water from the cavity to the bath water environment outside the housing through the outlet opening.

2. The apparatus of claim 1, further comprising a water filter positioned between the inlet opening and the cavity such that the bath water drawn from the bath water environment into the cavity through the inlet opening passes through the water filter before reaching the cavity.

3. The apparatus of claim 2, further comprising:
a watertight inner container, wherein the watertight inner container is impermeable to water;
a wireless charging circuit;
an electrical power source, wherein the electrical power source is electrically connected to the wireless charging circuit, the pump, and the heating element; and
a microcontroller, wherein the microcontroller is electrically connected to the electrical power source, the pump, and the heating element,
wherein the wireless charging circuit, the electrical power source, and the microcontroller are housed within the watertight inner container, and
wherein the housing further encloses the watertight inner container within the cavity.

4. The apparatus of claim 3, wherein the microcontroller is operable to control:
the operations of the pump to draw the bath water from the bath water environment outside the housing into the cavity through the inlet opening and to eject the heated bath water from the cavity to the bath water environment outside the housing through the outlet opening; and
the operation of the heating element to heat the bath water within the cavity.

5. The apparatus of claim 4, further comprising a wireless transceiver,
wherein the wireless transceiver is electrically connected to the microcontroller,
wherein the wireless transceiver is housed within the watertight inner container, and
wherein the wireless transceiver is operable to transmit and receive radio waves, thereby enabling the transfer of data between the microcontroller and an external input/output (I/O) device.

6. The apparatus of claim 5, further comprising:
at least one speaker, wherein the at least one speaker is electrically connected to the microcontroller and housed within the watertight inner container; and
a plurality of light-emitting diodes (LEDs), wherein the plurality of LEDs are electrically connected to the microcontroller, and wherein the plurality of LEDs are affixed to an exterior surface of the housing.

7. The apparatus of claim 6, further comprising a touchscreen display device,
wherein the touchscreen display device is operable to input one or more control signals to the microcontroller for controlling at least one of a status and an operation of the at least one speaker and the plurality of LEDs, and
wherein the touchscreen device is further operable to input one or more control signals to the microcontroller for controlling the operations of the pump and the heating element.

8. The apparatus of claim 7, wherein the housing includes a tapered back surface portion, whereby the tapered back surface portion enables the apparatus to accommodate a sloping surface of the bath water environment.

9. The apparatus of claim 8, further comprising one or more suction cups affixed to the tapered back surface portion of the housing, wherein the one or more suction cups are configured to adhere to the sloping surface of the bath water environment, thereby releasably affixing at least a portion of the apparatus to the sloping surface of the bath water environment.

10. The apparatus of claim 6, wherein the microcontroller is operable to control at least one of:
the operations of the pump and the heating element according to data received from the external I/O device via the wireless transceiver; and
at least one of a status and an operation of the at least one speaker and the plurality of LEDs according to data received from the external I/O device via the wireless transceiver.

11. The apparatus of claim 10, wherein the electrical power source is a battery, wherein the microcontroller is operable to transfer data to the external I/O device via the wireless transceiver, and wherein the data is at least one of a filter change alert and a low battery alert.

12. The apparatus of claim 11, wherein the housing is generally spherical.

13. The apparatus of claim 12, wherein an external diameter of the housing is less than six inches.

14. The apparatus of claim 11, wherein the housing is generally puck-shaped.

15. The apparatus of claim 11, further comprising:
a heating element temperature sensor, wherein the heating element temperature sensor is electrically connected to the microcontroller; and
a water temperature sensor, wherein the water temperature sensor is electrically connected to the microcontroller,
wherein the microcontroller is operable to:
obtain heating element temperature data from the heating element temperature sensor,
obtain water temperature data from the water temperature sensor, and
control the operation of the heating element based on the heating element temperature data and the water temperature data.

16. The apparatus of claim 1, wherein the bath water environment is a bathtub.

17. A bathing water heating apparatus, comprising:
a housing, wherein the housing includes at least one inlet opening and at least one outlet opening, wherein the housing encloses a first environment and a second environment, wherein the first environment is configured to be located above a water level line when the bathing water heating apparatus is utilized in a bathing water environment, and wherein the second environment is configured to be at least partially submerged in the bath water environment;
a battery, wherein the battery is enclosed within the first environment;
a microcontroller, wherein the microcontroller is enclosed within the first environment, and wherein the microcontroller is electrically connected to the battery;
a wireless transceiver, wherein the wireless transceiver is enclosed within the first environment, and wherein the wireless transceiver is electrically connected to the microcontroller;
a touchscreen display device, wherein the touchscreen display device is at least partially enclosed within the first environment, and wherein the touchscreen display device is electrically connected to the microcontroller;
a plurality of light-emitting diodes (LEDs), wherein the plurality of LEDs are affixed to an external surface of the housing, and wherein the plurality of LEDs are electrically connected to the microcontroller;
a pump, wherein the pump is enclosed within the second environment, and wherein the pump is electrically connected to the battery and the microcontroller;
a heating element, wherein the heating element is enclosed within the second environment, and wherein the heating element is electrically connected to the battery and the microcontroller;
wherein the battery is operable to provide electrical power to the microcontroller, the pump, and the heating element; and
wherein the microcontroller is operable to:
wirelessly communicate with an external input/output (I/O) device via the wireless transceiver,
at least one of receive data input and display video content via the touchscreen display device,
control at least one operating parameter of the plurality of LEDs,
control at least one operating parameter of the pump to draw water from the bathing water environment outside the housing into the second environment through the inlet opening,
control at least one operating parameter of the heating element to heat the water in the second environment, and
further control the at least one operating parameter of the pump to eject the heated water from the second environment to the bathing water environment outside the housing through the outlet opening.

18. The bathing water heating apparatus of claim 17, further comprising one or more suction cups affixed to the housing, wherein the one or more suction cups are configured to adhere to a surface of the bathing water environment, thereby releasably affixing at least a portion of the bathing water heating apparatus to the surface of the bathing water environment.

19. The apparatus of claim 17, wherein the housing is sized and shaped to rest the bathing water heating apparatus on a bridge structure spanning the bathing water environment.

20. An apparatus, comprising:
a battery;
a microcontroller, wherein the microcontroller is electrically connected to the battery;
a wireless transceiver, wherein the wireless transceiver is electrically connected to the microcontroller;
a speaker, wherein the speaker is electrically connected to the microcontroller;
at least one light-emitting diode (LED), wherein the at least one LED is electrically connected to the microcontroller;
a pump, wherein the pump is electrically connected to the battery and the microcontroller;
a heating element, wherein the heating element is electrically connected to the battery and the microcontroller;
a watertight inner container, wherein the watertight inner container is impermeable to water, and wherein the watertight inner container encloses the battery, the microcontroller, the wireless transceiver, and the speaker; and
a housing, wherein the housing encloses the watertight inner container, the pump, and the heating element within a cavity of the housing, wherein the housing includes at least one inlet opening and at least one outlet opening, and wherein the housing is sized and shaped to fit within at least a portion of a small water environment;
wherein the battery is operable to provide electrical power to the microcontroller, the pump, and the heating element, and
wherein the microcontroller is operable to:
wirelessly communicate with an external input/output (I/O) device via the wireless transceiver,
play audio content via the speaker,
control at least one operating parameter of the at least one LED,
control at least one operating parameter of the pump to draw water from the small water environment outside the housing into the cavity through the inlet opening,
control at least one operating parameter of the heating element to heat the water in the cavity, and
further control the at least one operating parameter of the pump to eject the heated water from the cavity to the small water environment outside the housing through the outlet opening.
